(19) United States
(12) Patent Application Publication
(10) Pub. No.: US 2010/0268785 A1
(43) Pub. Date: Oct. 21, 2010

(54) Apparatus and Method for Delivering Content Relating to a Desired Habit Change

(75) Inventors: Laurence Ellis Tobin, San Rafael, CA (US); Thomas Carey White, III, San Francisco, CA (US)

Correspondence Address: COOLEY LLP;ATTN: Patent Group, Suite 1100, 777 - 6th Street, NW, WASHINGTON, DC, 20001, US

(73) Assignee: Club One, Inc.

(21) Appl. No.: 12/823,117

(22) Filed: Jun. 24, 2010

Related U.S. Application Data
(63) Continuation-in-part of application No. 12/253,874, filed on Oct. 17, 2008.

(51) Int. Cl. G06F 15/16

(52) U.S. Cl. 709/206

(57) ABSTRACT

A computer readable storage medium includes executable instructions to deliver content relating to a desired habit change. The executable instructions include executable instructions to receive from a user an input relating to a desired habit change. Primary content relating to the desired habit change is invoked. The primary content is supplemented with diversion modules, where each diversion module is invoked at a specified primary content location and returns to the specified primary content location.

### CROSS REFERENCE TO RELATED APPLICATIONS

This application is a continuation-in-part of U.S. Ser. No. 12/253,874 filed on Oct. 17, 2008 entitled, “Apparatus and Method for Delivering Content Relating to a Desired Habit Change”.

### FIELD OF THE INVENTION

The invention relates generally to the field of human behavior modification and more particularly to an apparatus and method for generating and delivering content relating to a desired habit change.

### BACKGROUND OF THE INVENTION

Habits are acquired behavior patterns that are regularly followed until they have become almost involuntary. Neuroplasticity refers to the brain's ability to re-organize itself by forming new neural connections throughout an individual's life. When a new habit is introduced into an individual's life, evidence suggests that new connections get created in the individual's brain. As the individual practices and reinforces the habit, the connections in the brain get more established and eventually the habit becomes completely integrated into the individual's system.

While many behavioral programs have been developed to produce human behavior change, they are not specifically designed to utilize the brain's ability to adapt to appropriate stimuli needed to bring about small yet meaningful changes in the daily habits of an individual. It would be desirable to develop a technique to create new or improved habits for an individual. It would also be desirable to develop an end-to-end habit changing process for an individual that matches the individual's priorities, pace and willingness to accept a desired behavior modification.

### SUMMARY OF THE INVENTION

A computer readable storage medium includes executable instructions to deliver content relating to a desired habit change. The executable instructions include executable instructions to receive from a user an input relating to a desired habit change. Primary content relating to the desired habit change is invoked. The primary content is supplemented with diversion modules, where each diversion module is invoked at a specified primary content location and returns to the specified primary content location.

### BRIEF DESCRIPTION OF THE FIGURES

The invention is more fully appreciated in connection with the following detailed description taken in conjunction with the accompanying drawings, in which:

FIG. 1 illustrates a computer configured in accordance with one embodiment of the present invention.

FIG. 2 is an exemplary screen presented to a user to create an account to access content relating to a desired habit change.

FIG. 3 is an exemplary screen displayed to the user, upon successful user authentication, that summarizes the features of the content related to the desired habit change.

FIG. 4 is an exemplary screen presented to a user that displays a set of activities related to a desired habit change, in accordance with one embodiment of the present invention.

FIG. 5 illustrates a first activity state related to a desired habit change.

FIG. 6 illustrates a second activity state related to a desired habit change.

FIG. 7 illustrates a third activity state related to a desired habit change.

FIG. 8 illustrates a fourth activity state related to a desired habit change.

FIG. 9(a) illustrates a fifth activity state related to a desired habit change.

FIG. 9(b) is a screen shot that allows a user to select a desired goal related to a sequence of activities.

FIG. 10 illustrates an exemplary email encouragement message sent to a user, in accordance with one embodiment of the present invention.

FIG. 11 illustrates an exemplary email timeout message that is sent to a user, in accordance with one embodiment of the present invention.

FIGS. 12-17 illustrate various screen displays for managing content relating to a desired habit change for a user.

FIG. 18 illustrates sub-program processing utilized in accordance with an embodiment of the invention.

Like reference numerals refer to corresponding parts throughout the several views of the drawings.

### DETAILED DESCRIPTION OF THE INVENTION

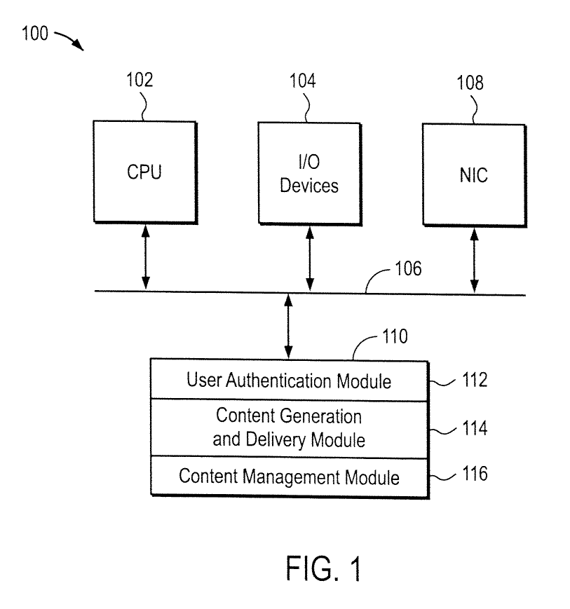

FIG. 1 illustrates a computer configured in accordance with one embodiment of the present invention. The computer 100 includes standard components, including a Central Processing Unit (CPU) 102 and input/output devices 104, which are linked by a bus 106. The input/output devices 104 may include a keyboard, mouse, touch screen, monitor, printer, and the like. A Network Interface Circuit (NIC) 108 provides connectivity to a network (not shown), thereby allowing the computer 100 to operate in a networked environment.

A memory 110 is also connected to the bus 106. The memory 110 includes one or more executable modules to implement operations of the invention. In one embodiment, the memory 110 includes a User Authentication Module 112, a Content Generation and Delivery Module 114 and a Content Management Module 116.

The User Authentication Module 112 includes executable instructions to authenticate a user's access to content relating to a desired habit change. The Content Generation and Delivery Module 114 includes executable instructions to invoke content relating to the desired habit change and deliver the content to a user in accordance with a content presentation factor. In one embodiment, and as will be discussed in greater detail below, the content presentation factor includes an activity flow parameter and a message delivery parameter. The Content Management Module 116 includes executable instructions to manage the content relating to the desired habit change for a user. The operations performed by the executable modules in the memory 110 are discussed in greater detail below. In a particular embodiment, content relating to a desired habit change is generated and delivered to a user using the Habit Changer® application, which is a trademark of Club One Inc. of San Francisco, Calif.

It should be noted that the executable modules stored in memory 110 are exemplary. Additional modules, such as an operating system or graphical user interface module may also be included. It should be appreciated that the functions of the modules may be combined. In addition, the functions of the modules need not be performed on a single machine. Instead, the functions may be distributed across a network, if desired. Indeed, the invention is commonly implemented in a client-server environment with various components being implemented at the client-side and/or server-side. It is the functions of the invention that are significant, not where they are performed or the specific manner in which they are performed.

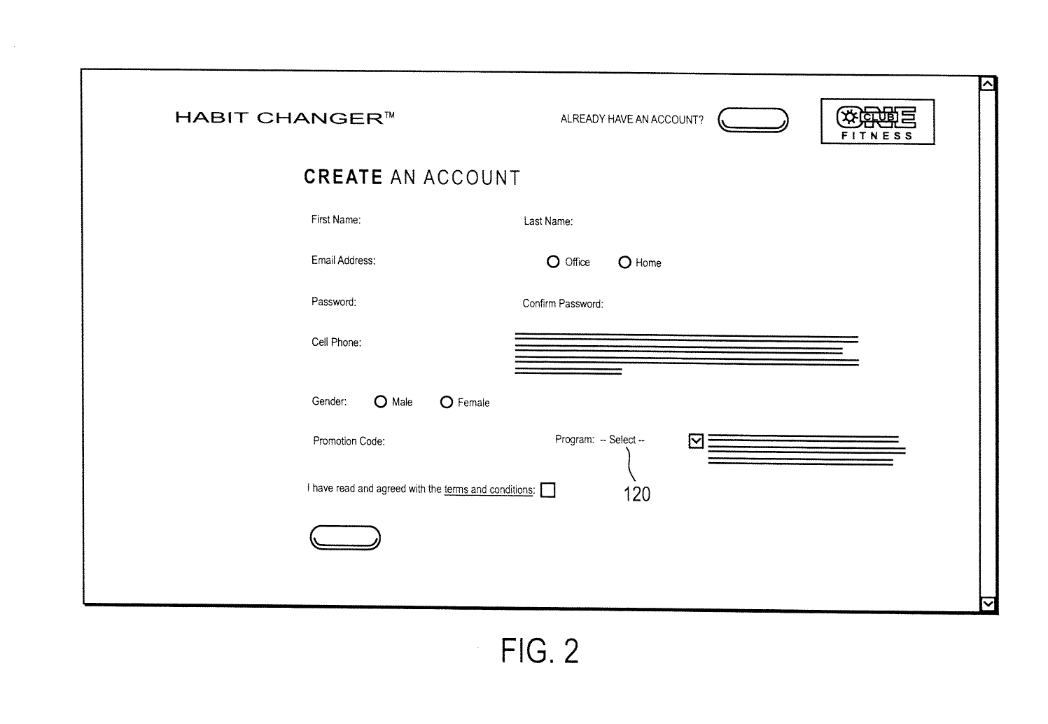

FIG. 2 is an exemplary screen presented to a user to create an account to access content relating to a desired habit change. As illustrated, one or more data fields capture account information related to a user. Observe that a user also selects appropriate content relating to a desired habit change from the “Program” data field 120. In one embodiment, the user's email address and password are used to authenticate a user's access to the content. The User Authentication Module 112 includes executable instructions to authenticate the user's access to the content and provide access to the appropriate content selected by the user. In one embodiment, the content relating to a desired habit change includes, but is not limited to, losing weight, feeling better, relationship with money, stress reduction, negative thinking and working better.

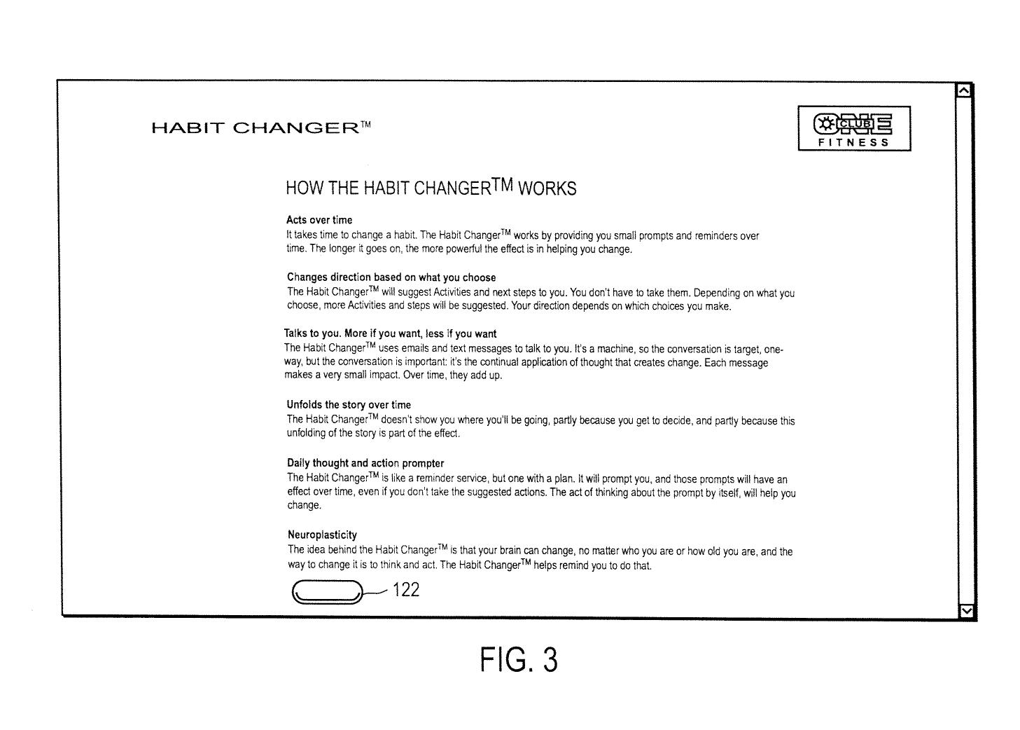

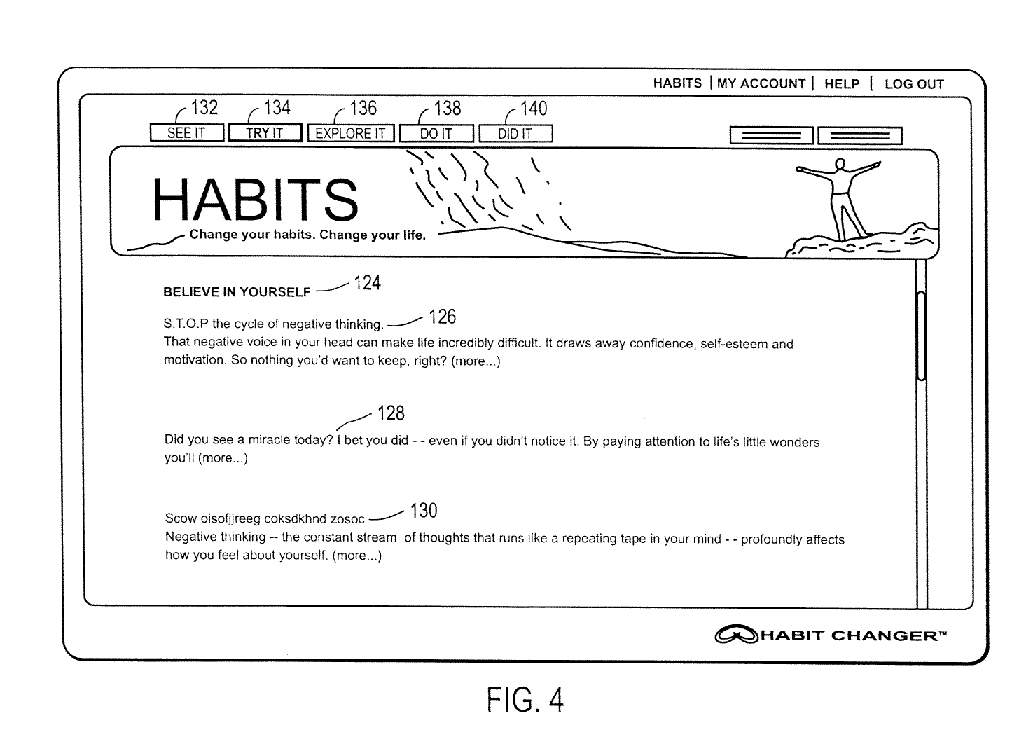

FIG. 3 is an exemplary screen displayed to the user upon successful user authentication, which summarizes the features of the content related to the desired habit change. Upon activating the “continue” tab 122, the user is presented with a screen display as shown in FIG. 4.

FIG. 4 is an exemplary screen presented to a user that displays a set of activities related to a desired habit change, in accordance with one embodiment of the present invention. In the illustrated example, appropriate content related to an underlying habit, to be employed by a user to achieve a desired habit change, is displayed to a user. A set of activities related to the underlying habit are also displayed. In the illustrated example, “Believe in yourself” 124 represents an underlying habit related to a desired habit change, and “S.T.O.P the cycle of negative thinking” 126, “Be thankful for small miracles” 128, and “It's time for a mental diet” 130 represent a set of activities related to the underlying habit to achieve the desired habit change. Note that, in one example, the screen shot shown in FIG. 4 displays content related to a desired habit change, “Feeling Better” in accordance with the user's selection of the appropriate content from the “Program” data field 120. In another example, if a user selected to view content related to a desired habit change such as, for example, “Losing Weight” by selecting the appropriate content from the “Program” data field 120, the user is presented with a screen that displays an underlying habit and a set of activities related to the desired habit change, “Losing Weight”. For example, an underlying habit associated with the desired habit change, “Losing Weight” may include, “Slow down your food consumption” and an activity related to the underlying habit may include, “Put down your fork between each bite when you are eating a meal”.

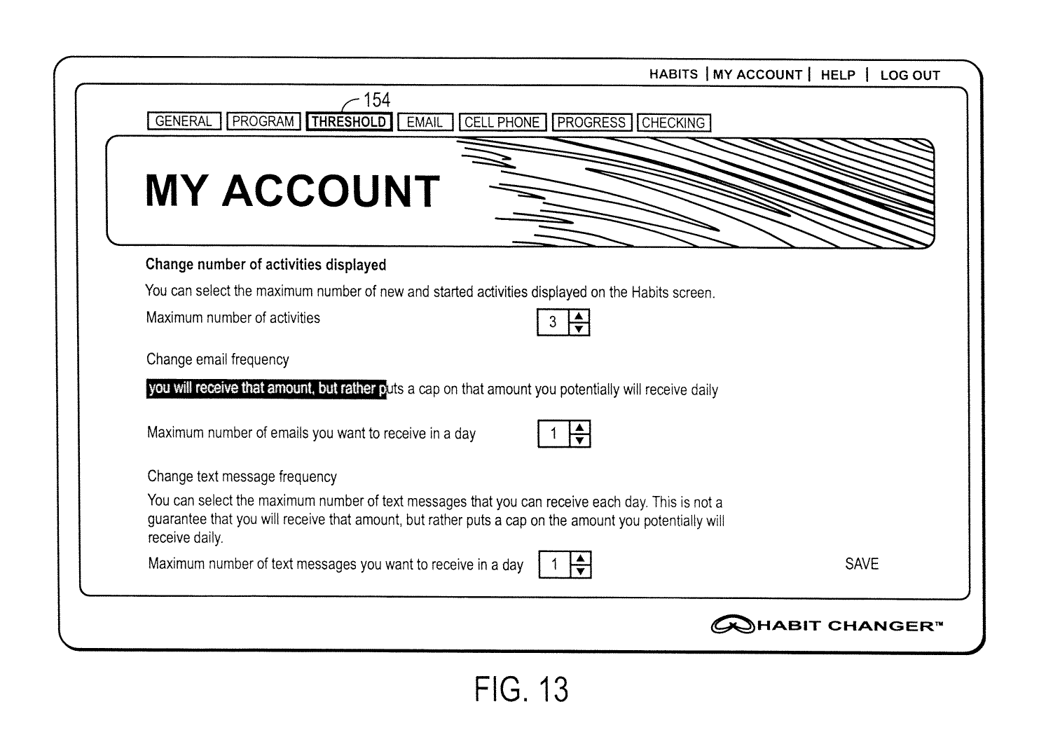

In one embodiment, “activities” represent the basic units of content that allow a user to achieve the desired habit change. Activities may be joined together in an event sequence related to the content. An event sequence determines the flow of the content in terms of the timing and delivery of the presentation of the content to the user. In one embodiment, an event sequence of activities related to the content may be pre-determined by executable instructions in the Content Generation and Delivery Module 114. In another embodiment, a desired event sequence of activities may be specified by the user, based on an activity flow parameter related to the generated content. The specification of an activity flow parameter ensures that the content is delivered to the user at the appropriate time, for the appropriate activity and in accordance with a specified controlled flow. In one embodiment, the activity flow parameters include an activity threshold parameter and an activity prioritization parameter. The activity threshold parameter enables a user to specify the number of activities that a user wishes to participate in at a given point in time. The activities are subsequently displayed to the user in accordance with the activity threshold parameter. In one embodiment, and as will be discussed in greater detail below, a “threshold” tab 154 as illustrated in FIG. 13 may be utilized by the user to specify the number of activities that a user wishes to participate in.

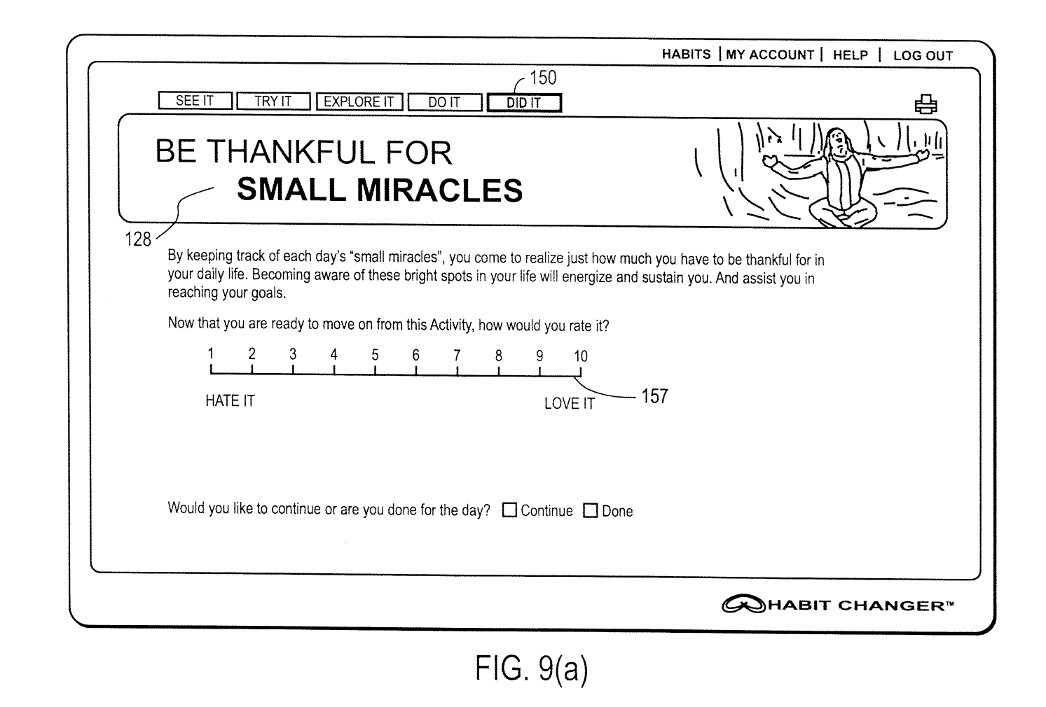

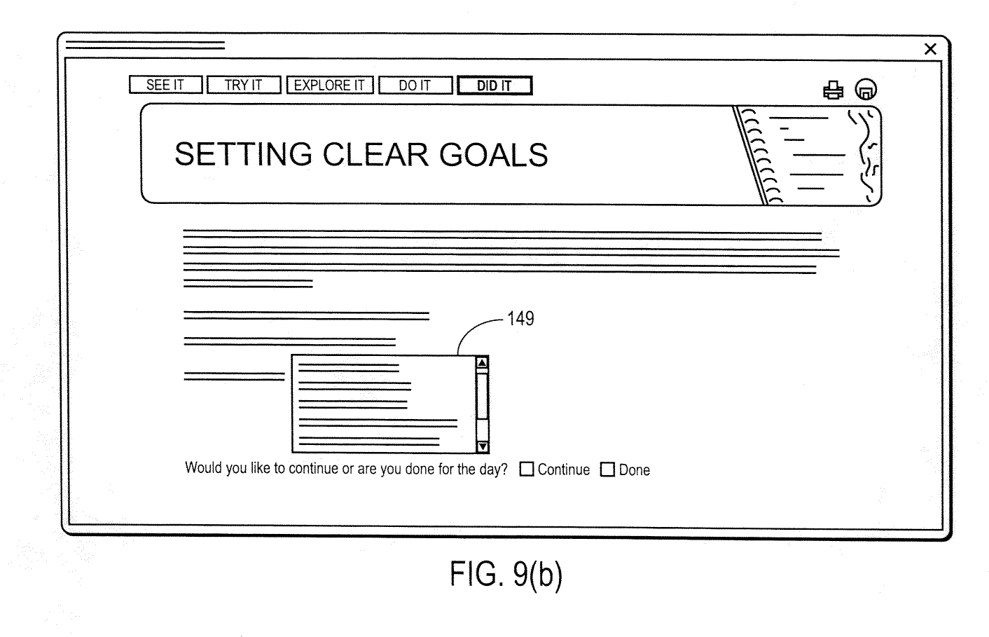

The activity prioritization parameter allows a user to specify a measurable goal related to a sequence of activities. Depending on the particular goal specified by the user, the user is provided with a unique flow of content related to a sequence of activities. In one embodiment, a “goal” tab 149 as illustrated in FIG. 9(b) may be utilized by the user to specify a measurable goal that the user desires to achieve. The activity flow parameters provide users with the ability of setting their own pace for interaction with the content, by enabling an “on the fly” user customization of the presentation and ordering of the content related to a desired habit change.

The Content Generation and Delivery Module 114 may further include executable instructions to specify one or more event sequence parameters such as an “event delay parameter” that specifies a time period (for example, the number of days) within which a specific activity within an event sequence has to be triggered to the user, and a “first through the gate parameter” to enable the delivery of a unique activity in an event sequence to the user. The specification of a “first through the gate parameter” prevents a user from being presented with the same activity twice. As discussed above, the order of activities displayed to a user may vary in accordance with the activity flow parameters specified by the user. The “first through the gate parameter” enables the creation of event sequences anticipating multiple paths that a user may engage in and ensures the uniqueness of the activities presented to the user.

A user may choose to skip a particular activity and move on to the next activity by selecting the “Skipped” activity tab 140. An activity may also be passively skipped by the Content Generation and Delivery Module 114 and another activity within the event sequence may be automatically selected by the Content Generation and Delivery Module 114 if the user has not performed the activity within a period of time. Accordingly, the path to move within an event sequence may be dynamically determined based on whether or not the user has completed an activity or has actively or passively skipped the activity. Observe that the user may view all the activities associated with an underlying habit by selecting the “All” activities tab 132, select a new activity associated with the underlying habit by selecting the “New” activities tab 134, view all the activities in progress by selecting the “Started” activities tab 136 and view all the completed activities by selecting the “Completed” activities tab 138.

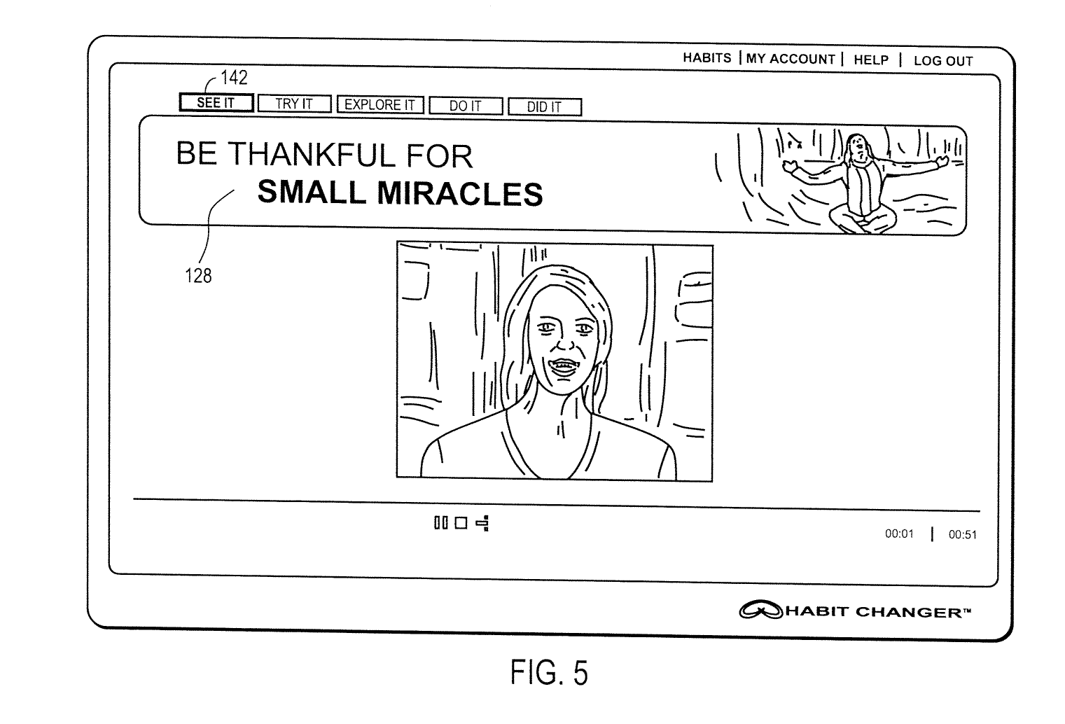

Each activity includes information related to an underlying habit related to the desired habit change and further includes one or more activity states. FIG. 5 illustrates a first activity state related to a desired habit change. In the illustrated example, the first activity state includes a “See It” activity state 142 that includes a video story about the activity, “Be thankful for small miracles” 128.

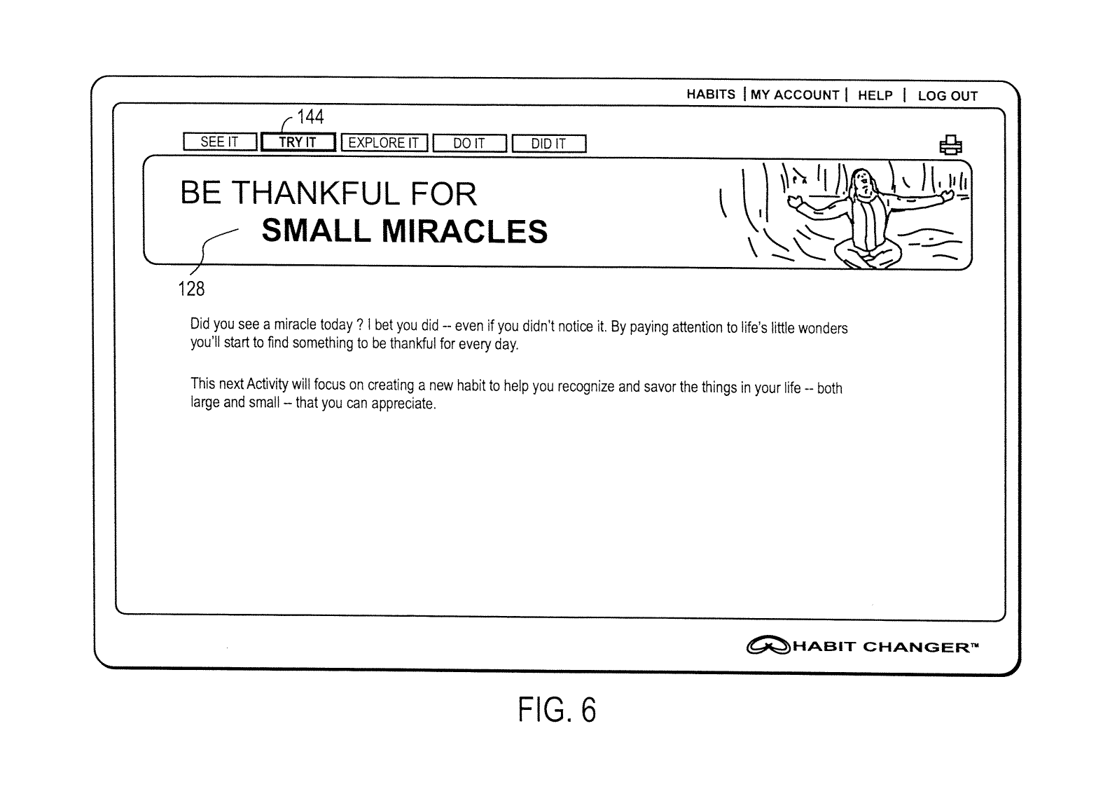

FIG. 6 illustrates a second activity state related to a desired habit change. In the illustrated example, the second activity state includes a “Try It” activity state 144 that includes a description of the activity, “Be thankful for small miracles” 128.

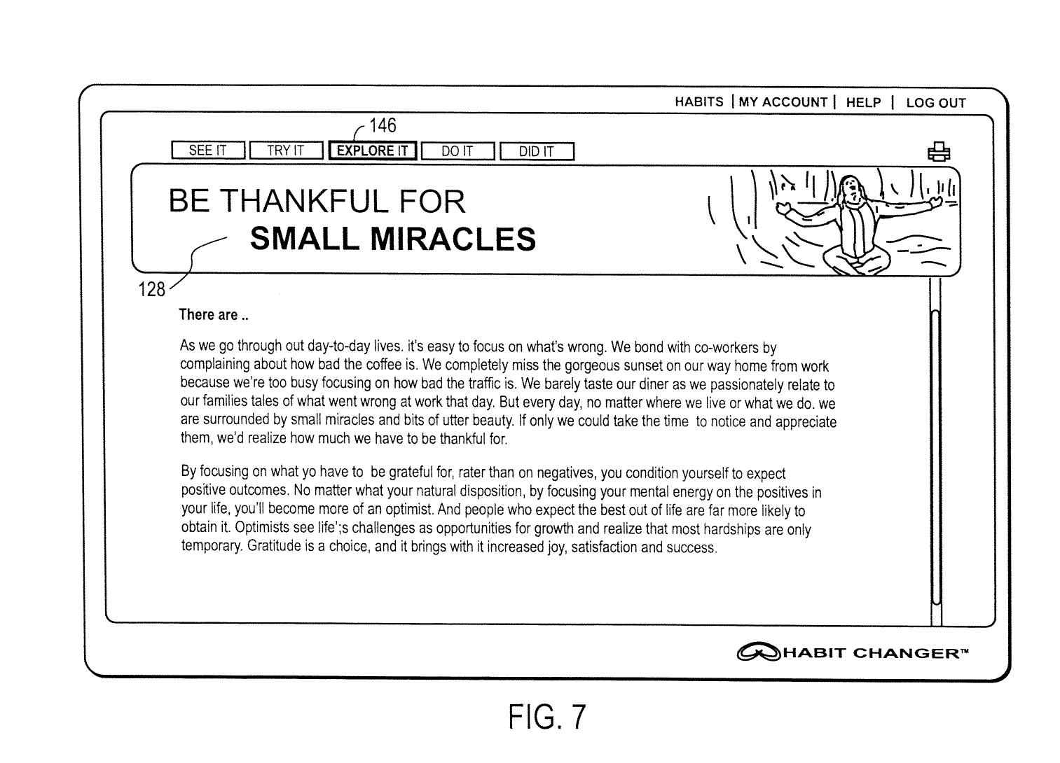

FIG. 7 illustrates a third activity state related to a desired habit change. In the illustrated example, the third activity state includes an “Explore It” activity state 146 that includes facts and other information about the activity, “Be thankful for small miracles” 128.

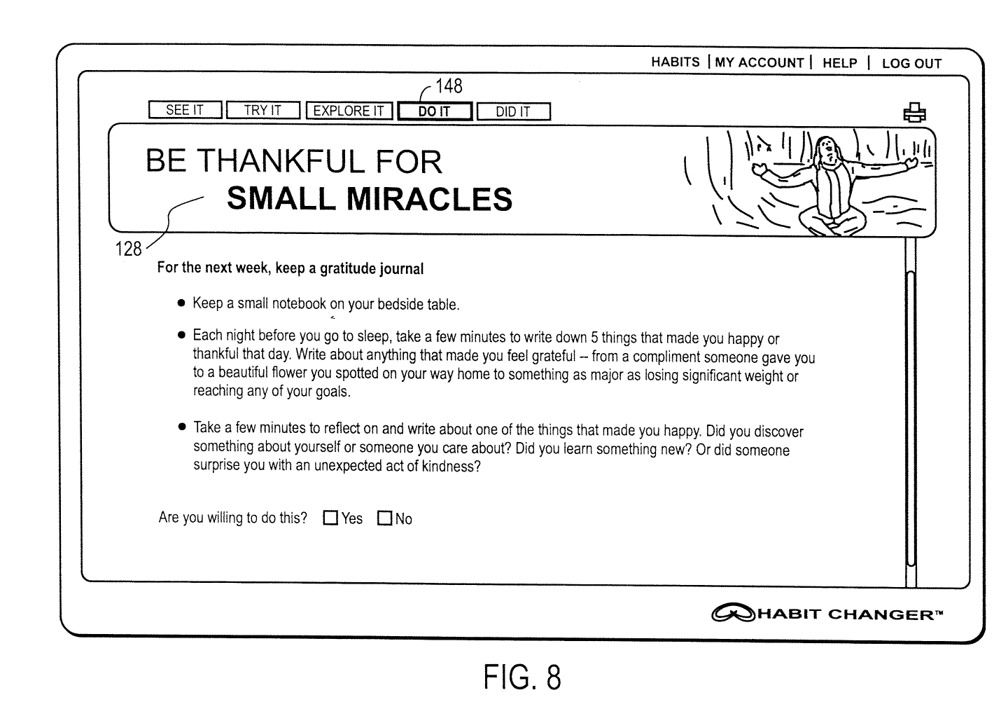

FIG. 8 illustrates a fourth activity state related to a desired habit change. In the illustrated example, the fourth activity state includes a “Do It” activity state 148 that includes a set of steps to perform the activity, “Be thankful for small miracles” 128.

FIG. 9(a) illustrates a fifth activity state related to a desired habit change. In the illustrated example, the fifth activity state includes a “Did It” activity state 150. In one example, the “Did It” activity state 150 includes a task related to the activity. In a particular embodiment, the user is asked to rate a performed activity. For example, a rating system 151 may be provided to the user, to receive a score from the user that is reflective of the user's experience in performing the particular activity. Activities that receive a higher score may be subsequently emphasized and activities that receive a lower score may be subsequently de-emphasized. In another embodiment, a series of different questions may be presented to a user upon completion of an activity and information regarding the user's experience may be stored for future analysis to determine an event sequence desired by the user. In yet another embodiment, a sequence of activities may be selected by allowing the user to specify a desired goal. FIG. 9(b) is a screen shot that allows a user to select a desired goal related to a sequence of activities. The user activates the “goal” tab 149 to choose a specific goal. Depending on the specific goal chosen by the user, the user is provided with a unique flow of content related to a sequence of activities. In one embodiment, and as discussed above, the desired goal may be specified by the activity prioritization parameter.

In another embodiment, the Content Generation and Delivery Module 114 includes executable instructions to specify one or more message delivery parameters related to the generated content. In a particular embodiment, the message delivery parameters include a text message threshold parameter and an email message threshold parameter. In one embodiment, a user may also specify threshold values for the message delivery parameters.

In one embodiment, the Content Generation and Delivery Module 114 includes executable instructions to send multiple and unique messages to a user. The types of messages delivered to the user include, but are not limited to, email timeout messages that provide a way to reach out to the user during dynamically specified time periods to remind the user to perform a specific activity, email follow-up messages that provide future follow-up of any completed activity to reinforce the establishment of the new habit, email tip suggestions that assist users while users attempt to change their habits and email/text encouragement messages that provide support and encouragement to the user during the habit changing process and that are delivered to the user at times during the day when the messages have the maximum impact on the user. For example, sending messages to the user in accordance with a changing schedule may have a greater impact on the user than sending messages to the user at the same time every day.

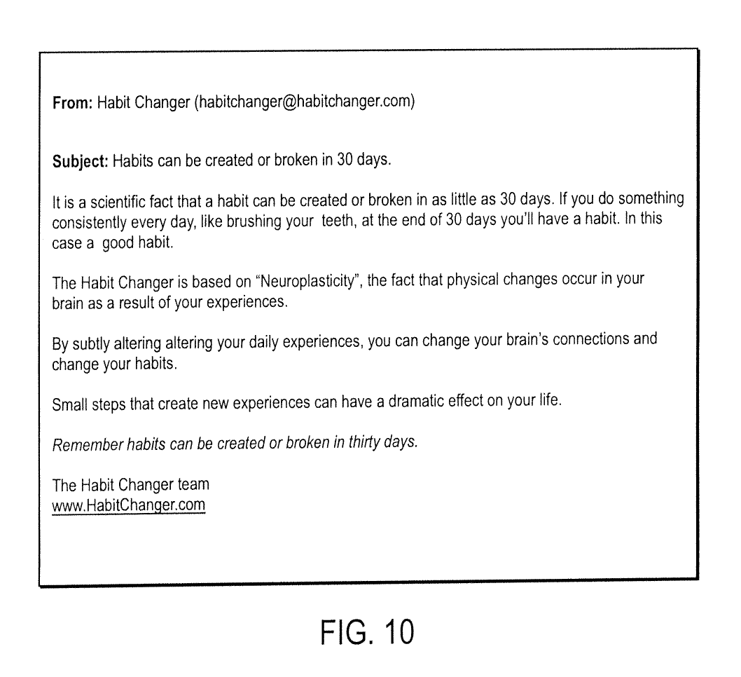

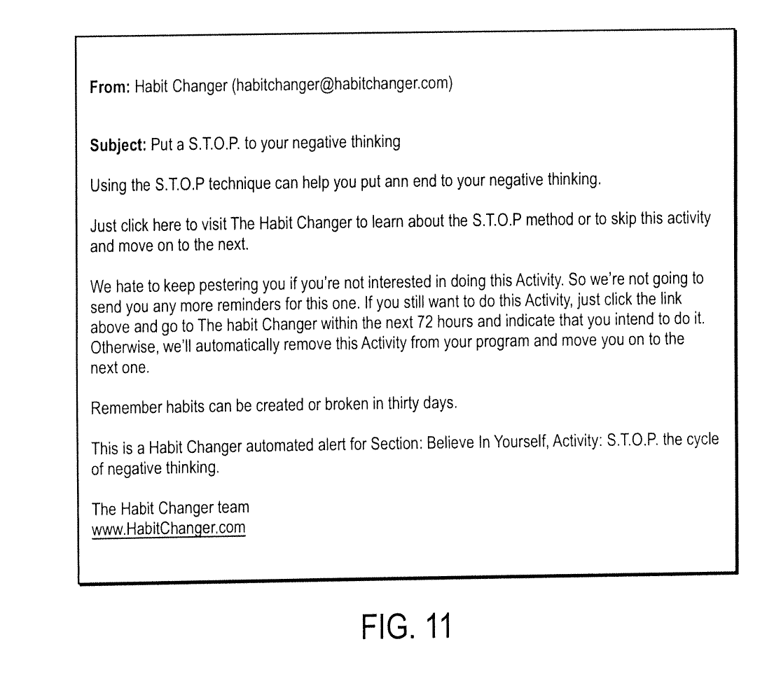

In a particular embodiment, the Content Generation and Delivery Module 114 includes executable instructions to generate messages in accordance with the content of information to be communicated to a user. For example, FIG. 10 illustrates an exemplary email encouragement message sent to a user, in accordance with one embodiment of the present invention. As illustrated, in one embodiment, the email encouragement message includes general information about the benefits of following healthy habits. FIG. 11 illustrates an exemplary email message that is sent to a user, in accordance with one embodiment of the present invention. As illustrated, in one embodiment, the email message reminds the user to perform a specific activity, related to a desired habit change.

In order to ensure that messages are not always delivered at the same time each day, in one embodiment, executable instructions in the Content Generation and Delivery Module 114 include the assignment of a random offset based on the specific prescribed time of day that the message needs to be delivered to the user. This enables the delivery of messages at specific time blocks during the day when the message has more relevance. Additionally, messages may be assigned priority levels and delivered to the user based on their priority levels.

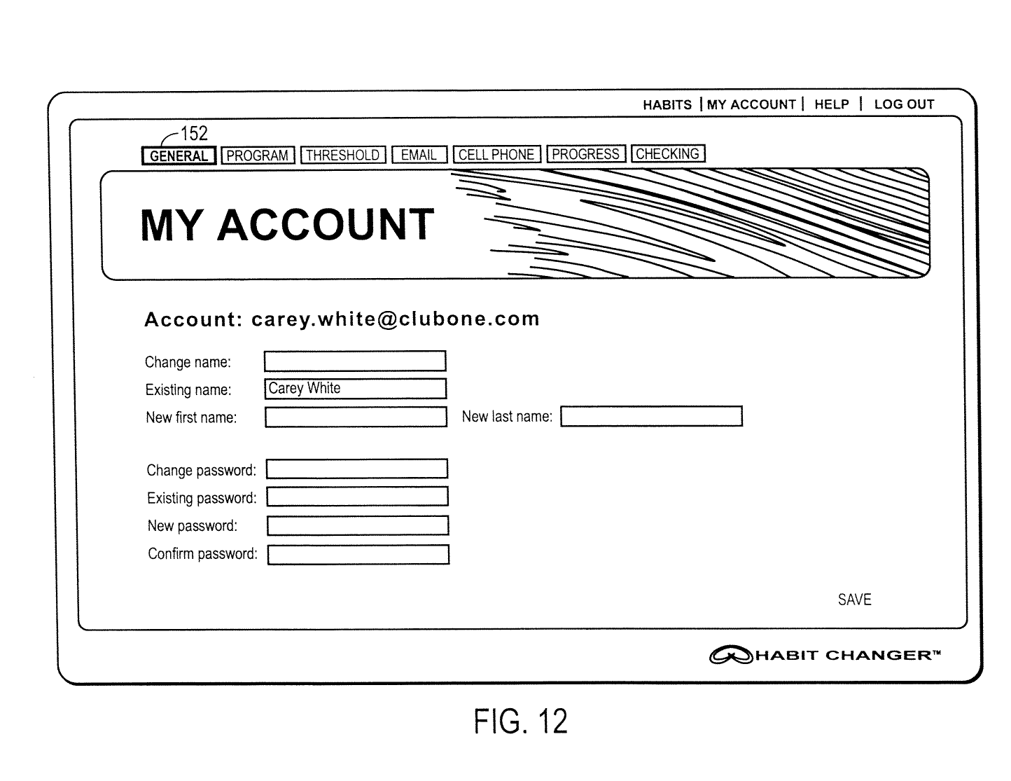

FIGS. 12-17 illustrate various screen displays for managing content relating to a desired habit change for a user. In one embodiment, the Content Management Module 116 includes executable instructions to manage the content relating to a desired habit change for a user. In the screen display shown in FIG. 12, a user may change his/her account information by activating the “general” tab 152. In one embodiment, users may freeze their accounts for a specified period of time and re-start their accounts at the end of the specified period, such as, for example, when a user wishes to go on a vacation and does not want to interact with the content while on vacation.

In the screen display illustrated in FIG. 13, a user activates the “threshold” tab 154 to specify the number of activities that the user wishes to participate in and a desired email frequency and a desired text message frequency of the number of messages that the user wishes to receive in a day. The number of activities may be specified using an activity threshold parameter, as discussed above. The desired email frequency and the desired text message frequency may be specified using one or more message delivery parameters including a text message threshold parameter and an email message threshold parameter, as discussed above.

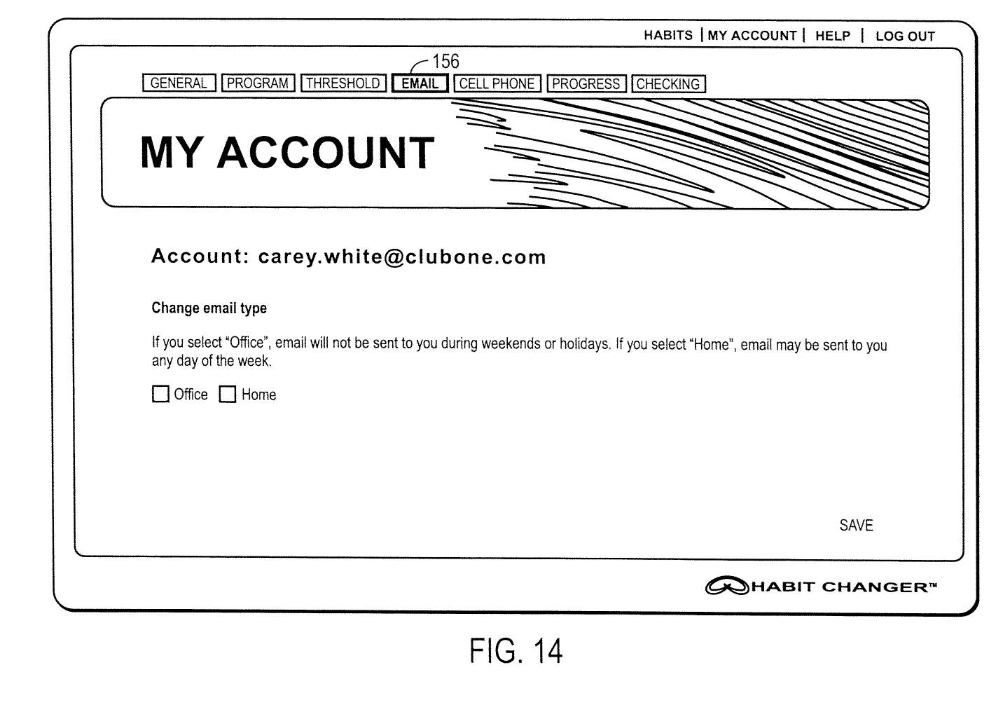

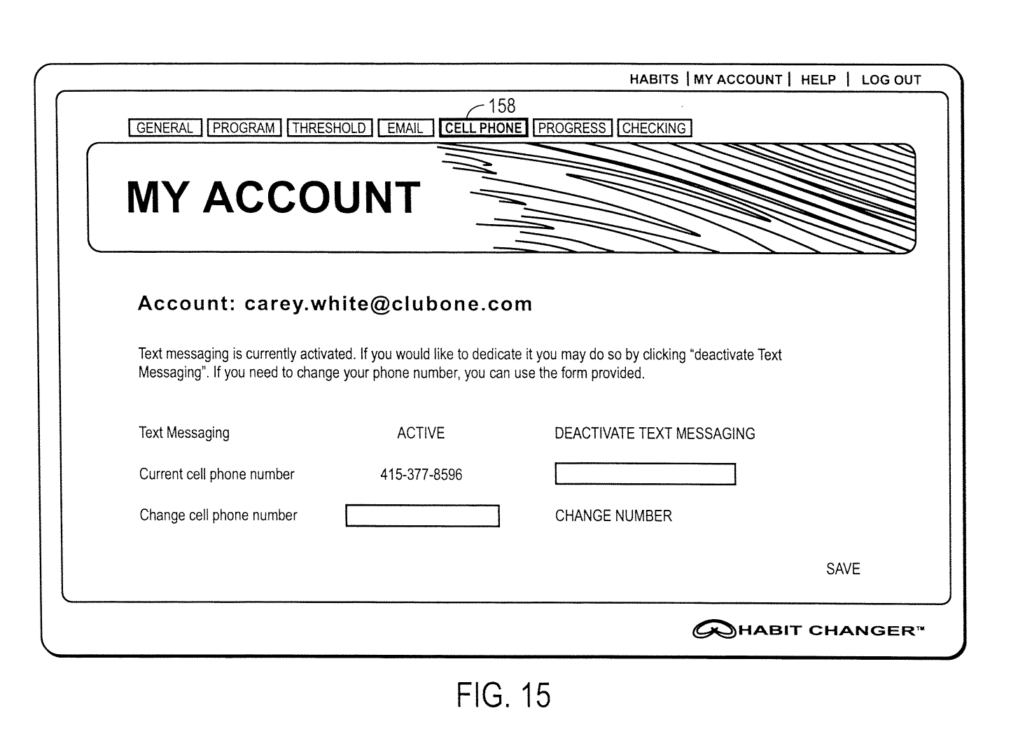

In the screen display illustrated in FIG. 14, a user may specify a particular email address that a user wishes to receive messages at by activating the “email” tab 156. In one embodiment, different delivery mechanisms may be employed depending on whether the user chooses to receive messages at his/her office email account or home email account. For example, if the user chooses to receive messages at his/her office email account, messages are not sent to the user during weekends and holidays. In the screen display shown in FIG. 15, a user may specify a change in his/her cell phone number by activating the “cell phone” tab 158.

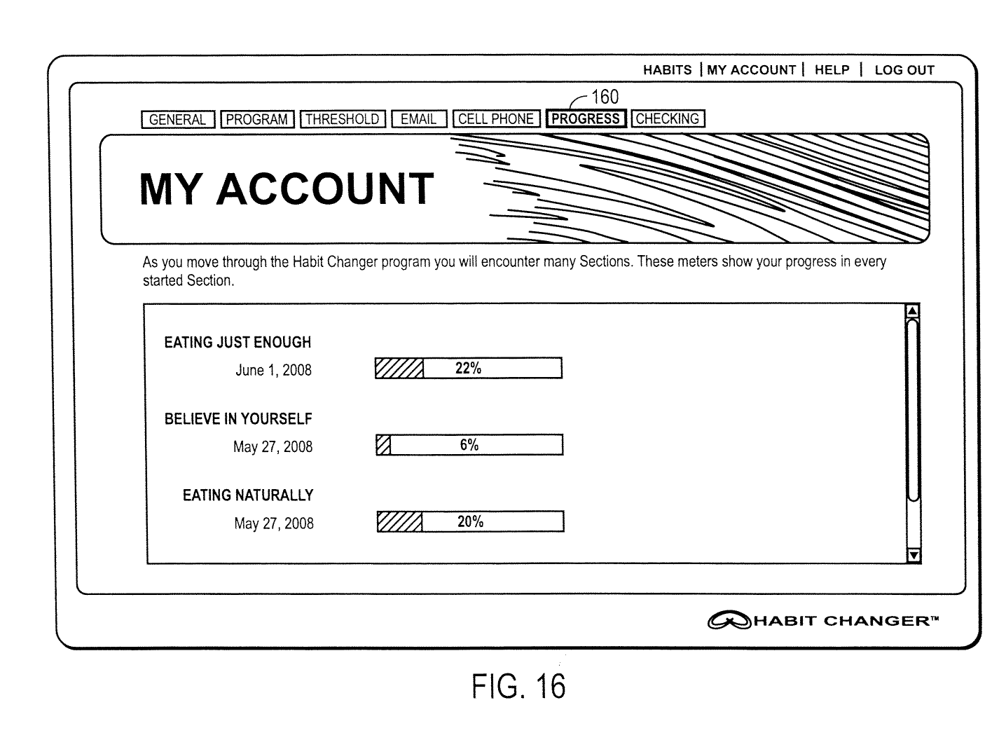

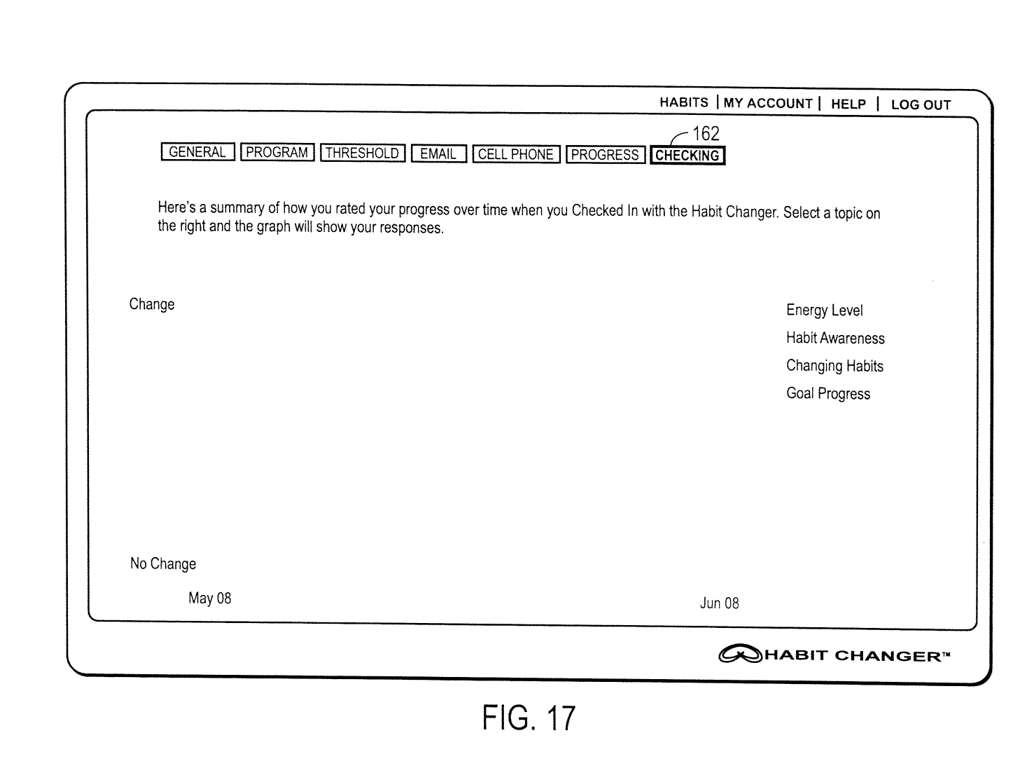

In the screen display shown in FIG. 16, a user may view individual progress levels associated with an underlying habit related to a desired habit change, by activating the “progress” tab 160. In the screen display shown in FIG. 17, a user may view a response pattern related to a desired habit change, by activating the “check-in” tab 162. In one embodiment, a set of check-in questions may be presented to a user periodically, to enable a user to rate various metrics related to a desired habit change and to obtain feedback on the progress level achieved by the user while performing a set of activities. A user may then view his/her pattern of responses over time by activating the “check in” tab 162. In the illustrated example, a user selects to view his/her pattern of responses related to the particular topic, “Energy Level”.

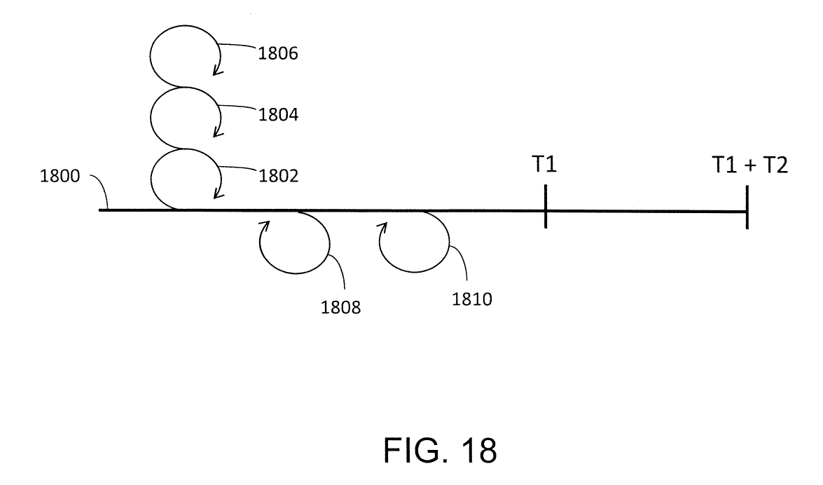

The ability of the system to adapt to a user's interactions is more fully appreciated with reference to FIG. 18. FIG. 18 represents the primary content of a habit change program as a line 1800. Typically, the habit change program is completed in a first time period (T1). However, individual features of the program may be explored in greater depth. One such feature is represented as loop 1802. This diversion allows the user to work a specific element discussed in the primary content. This feature may be of particular interest to the user. This diversion may be a separate software module that augments the primary content. This approach supports customization of the primary content.

The content associated with an individual diversion module may spawn exploration into a nested diversion module, as illustrated with loop 1804. Similarly, the content within loop 1804 may spawn another nested diversion module, illustrated with loop 1806. While a user is exploring a diversion of this type, outbound messaging (e.g., emails, texts) from the primary content is suspended. The diversion module may have its own outbound messaging that is invoked while the user is utilizing the division module.

After a diversion, programmatic control returns to the primary habit change program content illustrated with line 1800. The user proceeds to review this content, which may result in exploration of related content, shown as loops 1808 and 1810. Each loop or diversion module returns to the starting point that invoked the diversion module. The processing associated with the diversion modules extends the amount of time required to complete the primary content. If the diversion modules consumed an amount of time T2, then the total processing time for the habit change program is T1+T2.

Thus, in the midst of a time-sequenced behavior change course, a user may select a diversion. The diversion pauses the primary program content until the diversion is completed. The diversions allow for customization of an online training program. This customization can be created without altering the content of the primary program.

There are a number of advantages with the disclosed behavioral modification process. The ability of an individual's brain to reorganize and form new synaptic connections is steered to drive the individual's behavioral pattern to create new and improved habits by identifying activities that modify the underlying habits related to a desired habit change. Message delivery to users is tailored in accordance with the content of information to be communicated to a user. In addition, the presentation and delivery of the content in accordance with a content presentation factor coupled with activity and message thresholds and prioritization ensures that content related to a desired behavior change is delivered at the appropriate time for the appropriate activity within a specific controlled flow for each individual.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium comprising executable instructions to deliver content relating to a desired habit change, the executable instructions including executable instructions to:
receive from a user an input relating to a desired habit change;
invoke primary content relating to the desired habit change; and
supplement the primary content with diversion modules, wherein each diversion module is invoked at a specified primary content location and returns to the specified primary content location.

2. The computer readable storage medium of claim 1 further comprising executable instructions to provide nested diversion modules, wherein each nested diversion module is invoked from a diversion module location and returns to the diversion module location.

3. The computer readable storage medium of claim 1 further comprising executable instructions to suspend outbound messaging associated with the primary content when a diversion module is invoked.
